(19) United States
(12) Patent Application Publication
(10) Pub. No.: US 2015/0366730 A1
(43) Pub. Date: Dec. 24, 2015

(54) APPARATUS, SYSTEM, AND METHOD FOR A BED WITH AN ACTUATED DECK SECTION

(71) Applicant: Land America Health & Fitness Co. LTD, Xiamen (CN)

(72) Inventors: Jeff Pearson, Lacey, WA (US); Peng Fei Zhang, Xiamen (CN)

(21) Appl. No.: 14/744,017

(22) Filed: Jun. 18, 2015

Related U.S. Application Data
(60) Provisional application No. 62/014,096, filed on Jun. 18, 2014.
(60) Provisional application No. 62/037,074, filed on Aug. 13, 2014.
(60) Provisional application No. 62/063,378, filed on Oct. 13, 2014.

(51) Int. Cl. A61G 7/015; A61G 7/018

(52) U.S. Cl. CPC A61G 7/015; A61G 7/018

(57) ABSTRACT

A bed with an actuated deck section. The bed includes a deck section, a non-articulating component, and an actuator. The deck section is configured to articulate. In some embodiments, the actuator is connected to the deck section and the non-articulating component. A portion of the deck section, in one embodiment, is in an elevated position in response to an output rod of the actuator being in a relatively retracted position.

### CROSS-REFERENCE TO RELATED APPLICATIONS

This application claims the benefit of U.S. Provisional Patent Application No. 62/014,096, entitled “Apparatus, System, and Method for a Bed with an Actuated Deck Section,” which was filed on Jun. 18, 2014, and claims the benefit of U.S. Provisional Patent Application No. 62/037,074, entitled “Apparatus, System, and Method for a Bed with an Actuated Deck Section,” which was filed on Aug. 13, 2014, and claims the benefit of U.S. Provisional Patent Application No. 62/063,378, entitled “Apparatus, System, and Method for a Bed with an Actuated Deck Section,” which was filed on Oct. 13, 2014 all of which are hereby incorporated by reference.

### SUMMARY

An embodiment provides a bed with an actuated deck section. The bed includes a deck section, a non-articulating component, and an actuator. The deck section is configured to articulate. In some embodiments, the actuator is connected to the deck section and the non-articulating component. A portion of the deck section, in one embodiment, is in an elevated position in response to an output rod of the actuator being in a relatively retracted position. Other embodiments of an adjustable height bed are also described.

### BRIEF DESCRIPTION OF THE SEVERAL VIEWS OF THE DRAWINGS

FIG. 1 depicts a perspective view of one embodiment of a bed with an actuated deck section.

FIG. 2 depicts a side view of one embodiment of the actuator of FIG. 1.

FIG. 3 depicts a perspective view of one embodiment of the bushing of FIG. 2.

FIGS. 4A and 4B depict cutaway perspective views of one embodiment of the bed of FIG. 1 with the deck section in a lowered and raised position, respectively.

FIGS. 5A and 5B depict cutaway perspective views of one embodiment of the bed of FIG. 1 with the deck section in a lowered and raised position, respectively.

FIGS. 6A and 6B depict views of one embodiment of an actuator damper.

FIGS. 7A and 7B depict views of one embodiment of a bed with an articulating deck section.

FIGS. 8A and 8B depict views of one embodiment of a bed with a deck link.

FIG. 9 depicts a side view of one embodiment of a bed with a shock absorbing frame.

FIG. 10 depicts a cutaway perspective view of one embodiment of the shock absorbing frame of FIG. 9.

Throughout the description, similar reference numbers may be used to identify similar elements.

### DETAILED DESCRIPTION

In the following description, specific details of various embodiments are provided. However, some embodiments may be practiced with less than all of these specific details. In other instances, certain methods, procedures, components, structures, and/or functions are described in no more detail than to enable the various embodiments of the invention, for the sake of brevity and clarity.

While many embodiments are described herein, at least some of the described embodiments provide an apparatus, system, and method for a bed with an actuated deck section.

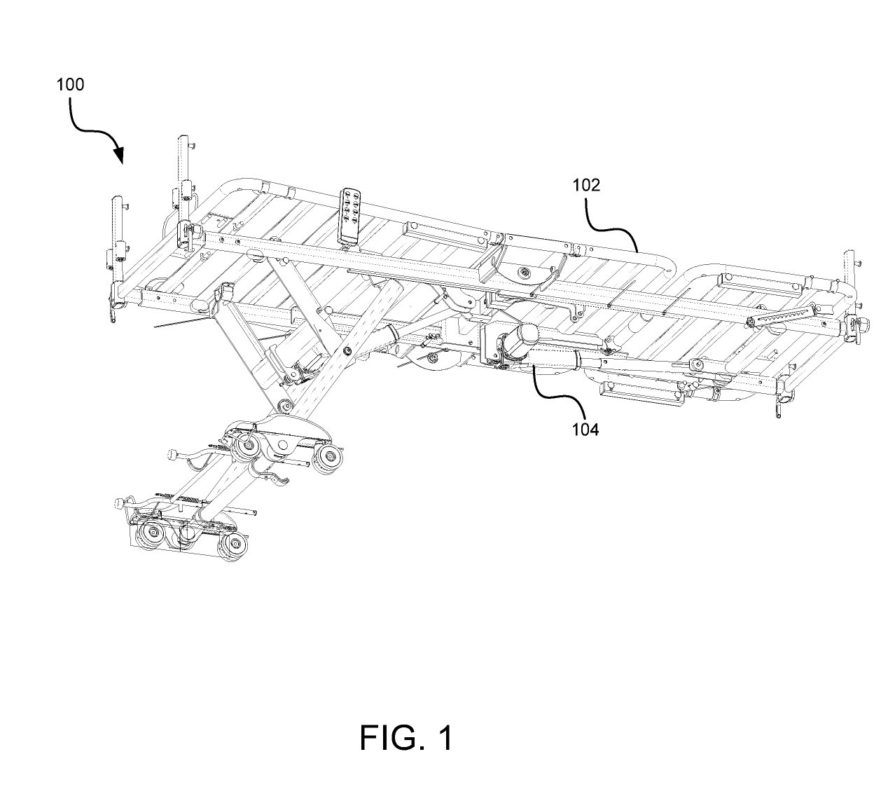

FIG. 1 depicts a perspective view of one embodiment of a bed 100 with an actuated deck section 102. The bed 100 includes at least one deck section 102 and at least one actuator 104. For simplicity, “deck section 102” and “actuator 104” as used herein shall refer to the at least one deck section 102 and the at least one actuator 104. The bed 100, in certain embodiments, includes a plurality of deck sections and a plurality of actuators. In FIG. 1, a leg assembly (not shown) and other components have been removed for clarity.

The deck section 102 is configured to articulate relative to other components of the bed 100. In the illustrated embodiment, the deck section 102 is located to support a mattress under a user's legs. Articulation of the deck section 102 may improve the comfort of the user or have therapeutic effects.

The deck section 102 articulates in response to the actuator 104 in one embodiment. The actuator 104 selectively generates a force to move the deck section 102. In some embodiments, the actuator 104 causes the deck section 102 to rotate around an axis.

In one embodiment, the actuator 104 exerts a pulling force on the deck section 102 to cause the deck section 102 to articulate such that at least a portion of the deck section 102 moves in an upward direction. In an alternative embodiment, the actuator 104 exerts a pushing force on the deck section 102 to cause the deck section 102 to articulate such that at least a portion of the deck section 102 moves in an upward direction.

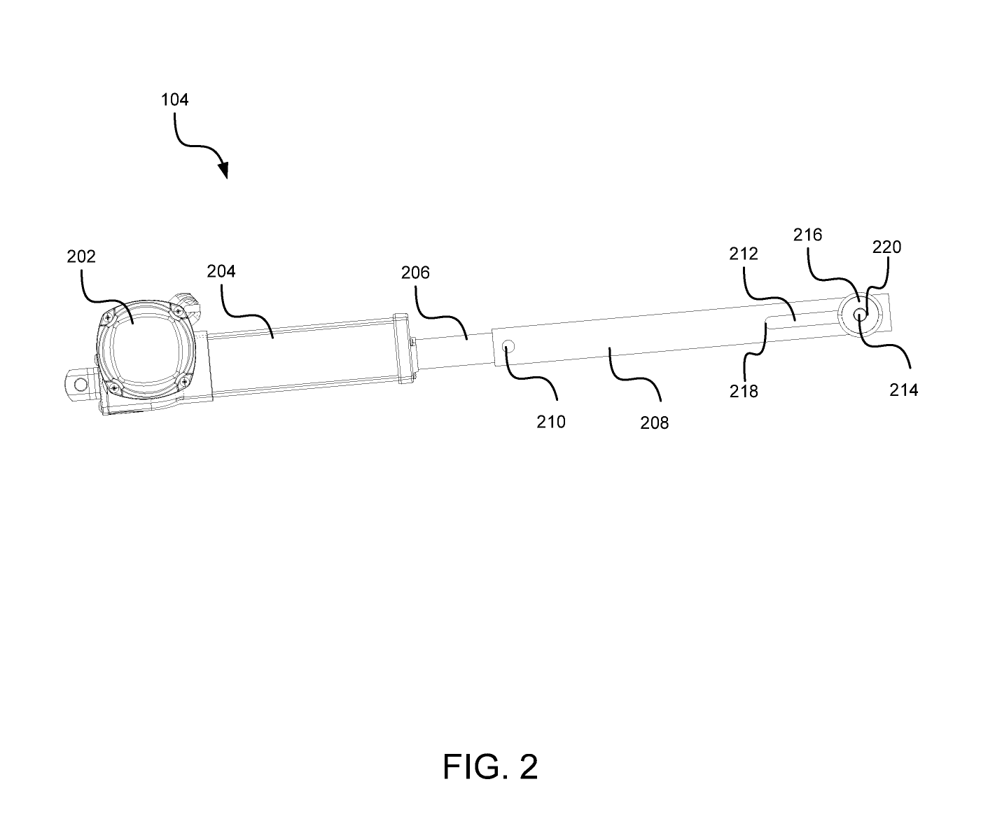

FIG. 2 depicts a side view of one embodiment of the actuator 104 of FIG. 1. The actuator 104 provides force to actuate the deck section 102. The actuator 104 may be any type of actuator capable of causing the deck section 102 to articulate. For example, the actuator 104 may be a linear actuator.

The actuator 104, in some embodiments, includes a motor 202, a housing 204, an output rod 206, and an extension tube 208. The motor 202 provides a force that causes the actuator 104 to actuate. In certain embodiments, the motor 202 is capable of providing a pushing force that causes the output rod 206 to extend in a direction away from the motor 202, and a pulling force that causes the output rod to retract in a direction toward the motor 202.

The motor 202 may be any type of motor known in the art. For example, the motor 202 may be an electric motor. In an alternate embodiment, the motor 202 may be replaced by any type of component known in the art for providing a force that creates motion. For example, the motor 202 may be a hydraulic motor or a pneumatic motor.

The housing 204 contains elements of the actuator 104 used in the operation of the actuator 104. For example, the housing 104 may contain gears, screws, belts or the like. In some embodiments, the housing 204 provides a space into which the output rod 206 retracts, and out of which the output rod 206 extends.

The output rod 206, in some embodiments, moves in response to activation of the actuator 104. The output rod 206 may receive a force from the motor 202 that causes the output rod 206 to move. In some embodiments, the output rod 206 moves linearly relative to the housing 204.

The extension tube 208 is connected to the output rod 206 and transfers the motion of the output rod 206 to other components of the bed 100. In some embodiments, the extension tube 208 is a distinct component separate from the output rod 206. The extension tube 208 may be connected to the output rod 206 in a manner that restricts movement of the extension tube 208 relative to the output rod 206. For example, the extension tube 208 may be a tube sized to slide over a portion of the output rod 206. The extension tube 208 may be fastened to the output rod 206 by a fastener 210.

In an alternative embodiment, the extension tube 208 is formed integrally with the output rod 206. For example, the output rod 206 may be of a length and include structures that allow it to perform the functions of both the output rod 206 and the extension tube 208.

The extension tube 208, in one embodiment, includes a connection point 212 for connecting the extension tube 208 to other components of the bed 100. In some embodiments, the connection point 212 provides a connection that allows the connection components to translate along a line relative to the extension tube 208. For example, the connection point 212 may be an elongated slot that allows an axle 214 to translate along the length of the slot. The slot may include a proximal end 218 and a distal end 220 that define the extent of the line in which the axle 214 is allowed to translate. In some embodiments, the slot is rounded on the ends and sized to restrict motion of the axle 214 in directions other than the line along which the axle 214 is allowed to translate.

In an alternate embodiment, the connection point 212 restricts motion of the axle 214 relative to the connection point 212. For example, the connection point 212 may be a hole in the extension shaft 208 through which the axle 214 is disposed.

In one embodiment, the axle 214 supports a bushing 216. The bushing 216 includes a compliant material configured to absorb shocks that might otherwise travel through the components of the actuator 104 and the bed 100.

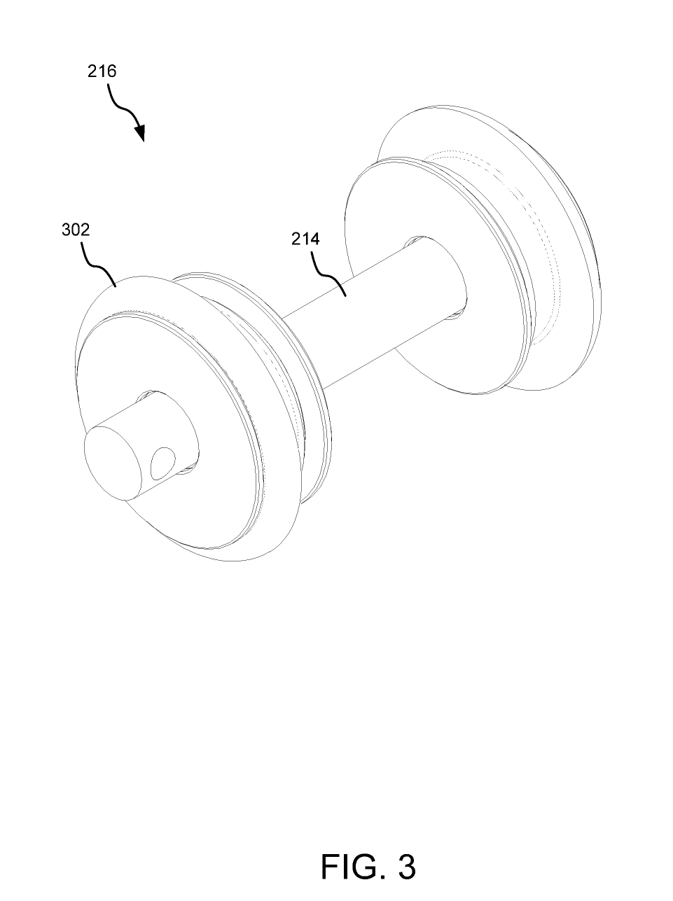

FIG. 3 depicts a perspective view of one embodiment of the bushing 216 of FIG. 2. The bushing 216, in one embodiment, includes the axle 214 and a compliant component 302. The bushing 216 connects to the extension shaft 208 at the connection point 212.

The compliant component 302, in one embodiment, deforms in response to force between the extension shaft 208 and other components of the bed 100. Deformation of the compliant component 302 may absorb some shock loads that would otherwise be transmitted through the system. Absorption of this shock may increase reliability of components of the bed 100, such as the actuator 104. Absorption of this shock may also increase the comfort of a user. The compliant component 302 may be disposed between the axle 214 and a non-articulating component of the bed 100.

The compliant component 302 may include any material capable of deforming in response to a shock load. For example the compliant component 302 may include a flexible polymer. In one example, the compliant component 302 includes a thermoplastic elastomer (“TPE”), including but not limited to Styrenic block copolymers (TPE-s), Polyolefin blends (TPE-o), Elastomeric alloys (TPE-v or TPV), Thermoplastic polyurethanes (TPU), Thermoplastic copolyester, or Thermoplastic polyamide. In another example, the compliant component 302 may include polyvinyl chloride (PVC), low durometer PVC, or a urethane.

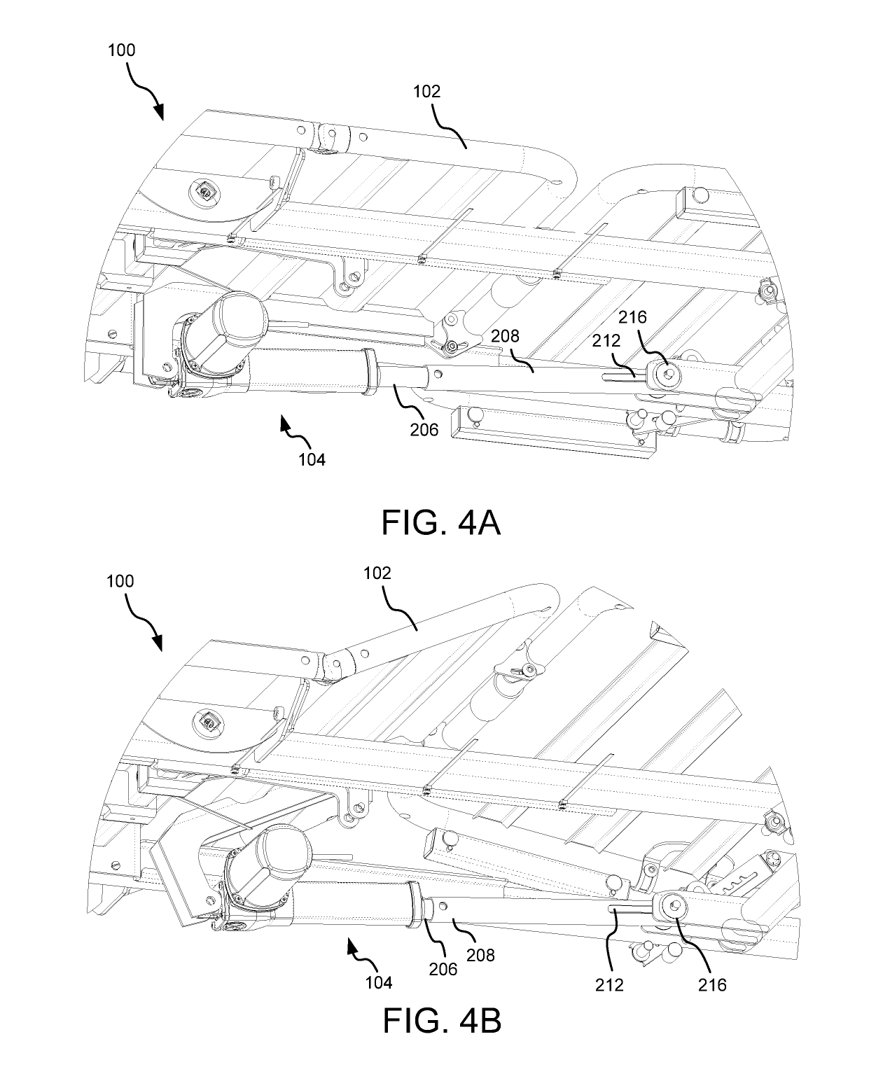

FIGS. 4A and 4B depict cutaway perspective views of one embodiment of the bed 100 of FIG. 1 with the deck section 102 in a lowered and raised position, respectively. In FIG. 4A, the output rod 206 is in a relatively extended position and the deck section 102 is in a relatively lowered position. In FIG. 4B, the output rod 206 is in a relatively retracted position, the bushing 216 is at the distal end 220 of the connection point 212, and the deck section 102 is in a relatively raised position. Retraction of the output rod 206 in one embodiment causes the bushing 216 to translate to the distal end 220 of the connection point 212. Retraction of the output rod 206 when the bushing 216 is at the distal end 220 of the connection point 212 causes the deck section 102 to rotate in an upward direction relative to other components of the bed 100.

In some embodiments, extension of the output rod 206 when the deck section 102 is rotated in an upward direction relative to other components of the bed 100 may allow the deck section 102 to rotate in a downward direction relative to other components of the bed 100. Depending on other factors, the weight of the deck section 102 and objects supported by the deck section 102 cause the bushing 216 to remain at the distal end 220 of the connection point 212 and the deck section 102 to lower as the output rod 206 extends.

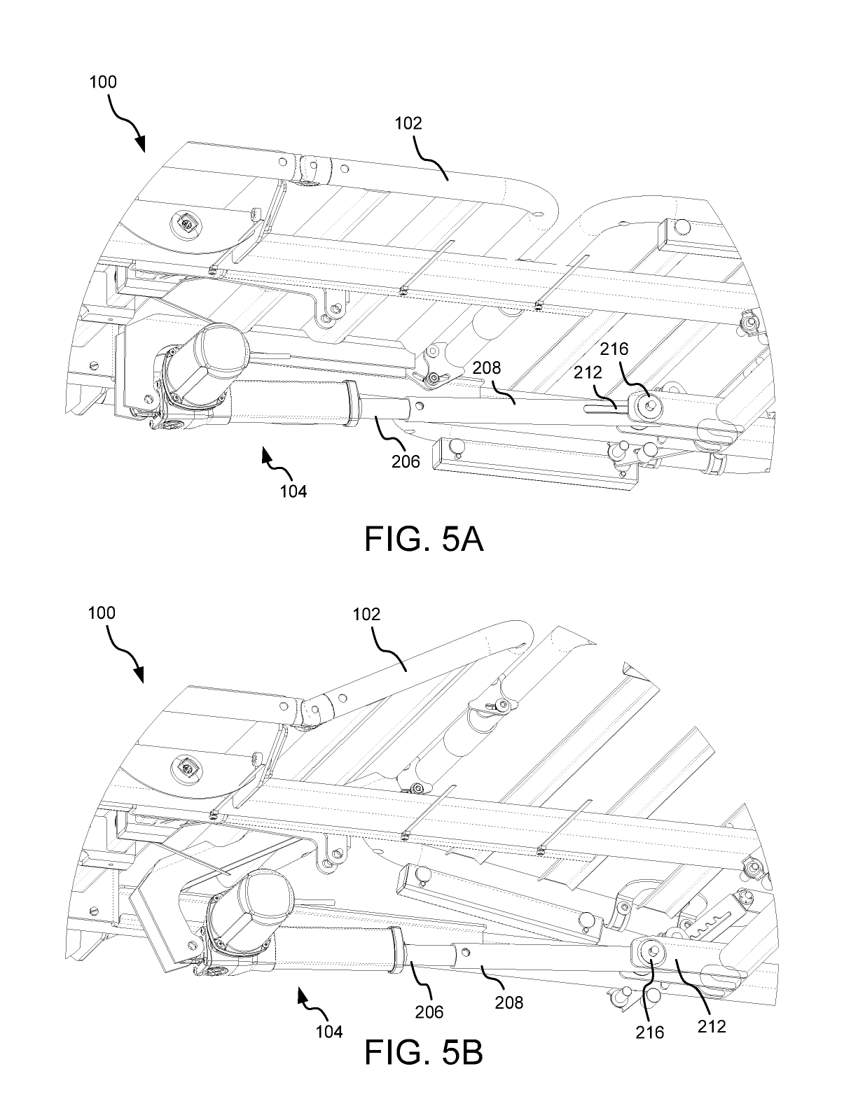

In some embodiments, if the deck section 102 is held in a relatively upward position as the output rod 206 extends, for example, if an object is positioned between the deck section 102 and other components of the bed, the connection between the bushing 216 and the extension shaft 208 may allow the output rod 206 to extend and the deck section 102 to remain relatively stationary. This mitigates crush hazards by allowing extension of the output rod 206 without crushing an object located between the deck section 102 and other components of the bed 100. This may also mitigate damage to the bed by reducing strain on the actuator 104 when there is an object between the deck section 102 and other components of the bed 100. The slot defined in part by the distal end 220 and the proximal end 218 of the connection point 212 allows the bushing 216 to translate along the slot for a portion of the extension of the output rod 206. As the bushing 216 translates, the deck section 102 is allowed to remain in a relatively raised position. An example of one embodiment of a condition where the output rod 206 is extended and the deck section 102 is allowed to remain in a raised position is shown in FIG. 5B below.

FIGS. 5A and 5B depict cutaway perspective views of one embodiment of the bed 100 of FIG. 1 with the deck section 102 in a lowered and raised position, respectively. In both FIG. 5A and 5B, the output rod 206 is in a relatively extended position. In FIG. 5A, the deck section 102 is in a relatively lowered position, and in FIG. 5B the deck section 102 is in a relatively raised position. In FIG. 5A, the bushing 216 is near the distal end 220 of the connection point 212, and in FIG. 5B, the bushing 216 is nearer to the proximal end 218 of the connection point 212.

FIGS. 5A and 5B show an upward freedom of motion in some embodiments for the deck section 102 to some degree independent of the motion of the actuator 104. This upward freedom of motion mitigates crush hazards that may otherwise exist in the bed 100. In the illustrated embodiments, an upward force on the deck section 102, such as may be caused by an object between the deck section 102 and other components of the bed 100 or by lifting the deck section 102, may allow the deck section 102 to be in a relatively raised position whether the output rod 206 is in a relatively extended position, as shown in FIG. 5B, or in a relatively retracted position, as shown in FIG. 4B.

In some illustrated embodiments, the slotted connection point 212 is disposed on the extension shaft 208. As will be appreciated by one skilled in the art, the slotted connection point 212 could perform a similar function if disposed on several other components, including but not limited to the output rod 206, a component of the deck section 102, or a non-articulating component of the bed 100. Such embodiments are within the scope of this disclosure. In another embodiment, the actuator is a pull-only actuator.

In some illustrated embodiments, the bushing 216 is disposed between the extension shaft 208 and a non-articulating component of the bed 100. As will be appreciated by one skilled in the art, the bushing 216 could perform a similar function if disposed between several other components, including but not limited to between the output rod 206 and the extension rod 208 or between the actuator 104 and the deck section 102. Such embodiments are within the scope of this disclosure.

In some illustrated embodiments, the housing 204 of the actuator 104 is connected to the deck section 102 and the output rod 206 is connected via the extension shaft 208 to a non-articulating component of the bed 100, such as a frame. As will be appreciated by one skilled in the art, the actuator 104 could be reversed, such that the output rod 206 is connected via the extension shaft 208 to the deck section 102 and the housing 204 is connected to a non-articulating component of the bed 100, such as a frame. Such embodiments are within the scope of this disclosure.

In some illustrated embodiments, the connection point 212 is a slot with a distal end 220 and a proximal end 218. As will be appreciated by one skilled in the art, the connection point 212 could be a connection that does not allow translation, such as a hole in which the bushing 216 is fixed. Such embodiments are within the scope of this disclosure.

In some illustrated embodiments, the actuated deck section 102 is a foot section of the bed 100. As will be appreciated by one skilled in the art, the actuated deck section 102 could be any section of the bed 100, including an upper body section. Such embodiments are within the scope of this disclosure.

Components of the bed 100, including the deck section 102, the actuator 104, the output rod 206, the extension shaft 208, the axle 214, and the bushing 216 may include any material capable of providing the necessary strength, durability, and stiffness. For example, components of the bed 100 may include steel, stainless steel, aluminum, titanium, a composite material, or a polymer.

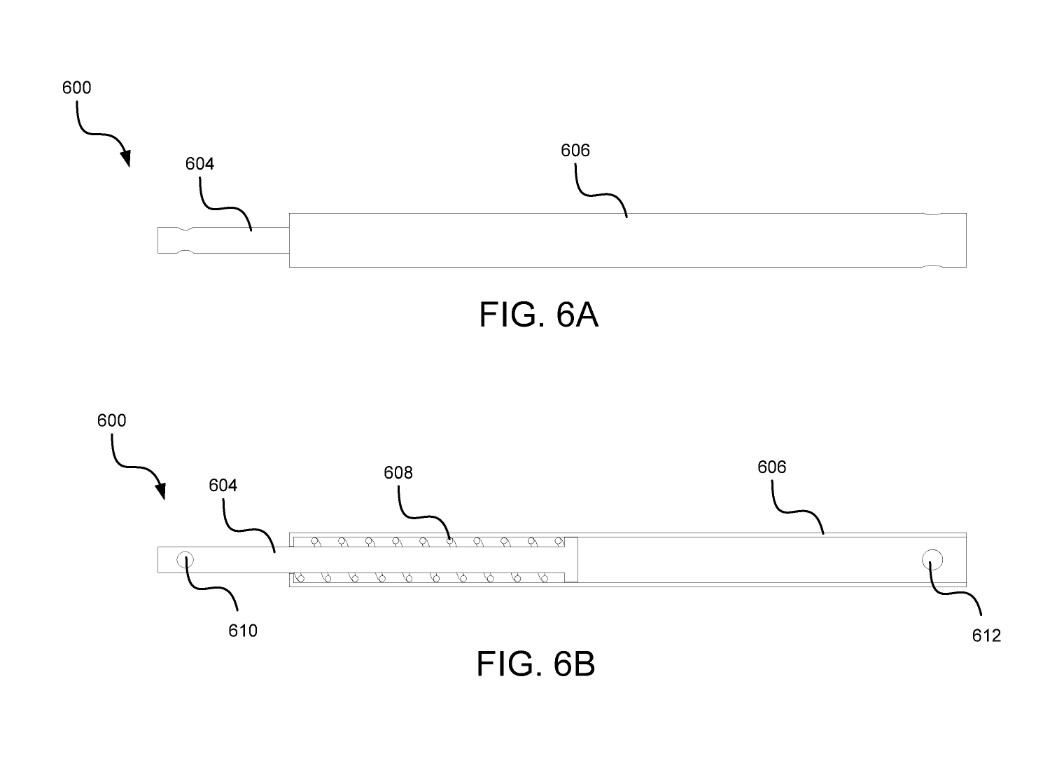

FIGS. 6A and 6B depict views of one embodiment of an actuator damper 600. The actuator damper includes a damper rod 604, a damper tube 606, and a compliant structure 608. The actuator damper 600 is connected between an actuator and a component of a bed and mitigates shock loads that would otherwise be transmitted to the actuator. The actuator damper 600 may protect the actuator from damage that would otherwise be caused by shock loads.

As shown in FIGS. 6A and 6B, in some embodiments, the damper rod 604 and the damper tube 606 are coupled via the compliant structure 608. At least some force applied to a first end 610 of the actuator damper 600 may be transmitted through the compliant structure 608 to a second end 612 of the actuator damper 600. In some embodiments, pulling forces, where the force on the first end 610 is in a direction opposite to the force on the second end 612, are at least partially transmitted through the compliant structure 608.

In response to a relatively rapid change in force applied to either the first end 610 or the second end 612, the compliant structure 608 may deform. Deformation of the compliant structure 608 under a shock load may dampen the shock transmitted through the actuator damper 600 between the first end 610 and the second end 612. In some embodiments, the actuator damper 600 mitigates shock loads due to pulling forces. Dampening of shock loads may protect the actuator from damage.

In some embodiments, the compliant structure 608 is a structure that deforms under an applied force. In some embodiments, the compliant structure 608 is stiff enough that normal operating forces applied by the actuator will not appreciably deform the compliant structure 608, but relatively high shock forces will be at least partially absorbed by the compliant structure 608. The compliant structure 608 may be any type of compliant structure known in the art. For example, the compliant structure 608 may be a coil spring. In certain embodiments, the compliant structure 608 is made of metal, such as spring steel. In another example the complaint structure 608 may include a compliant polymer. For example, the compliant structure 608 may be a synthetic rubber that deforms under a load. In yet another embodiment, the compliant structure 608 may be a hydraulic or pneumatic shock absorber.

The actuator damper 600 may be installed in any orientation between the actuator and a connection point to a bed. For example, the first end 610 may be connected to an output rod of the actuator and the second end 612 may be connected to a mount point on the bed. In another example, the second end 612 may be connected to an output rod of the actuator and the first end 610 may be connected to a mount point on the bed. In yet another example, the actuator damper 600 may be connected in any orientation between the actuator and a mount point on an articulating portion of the bed.

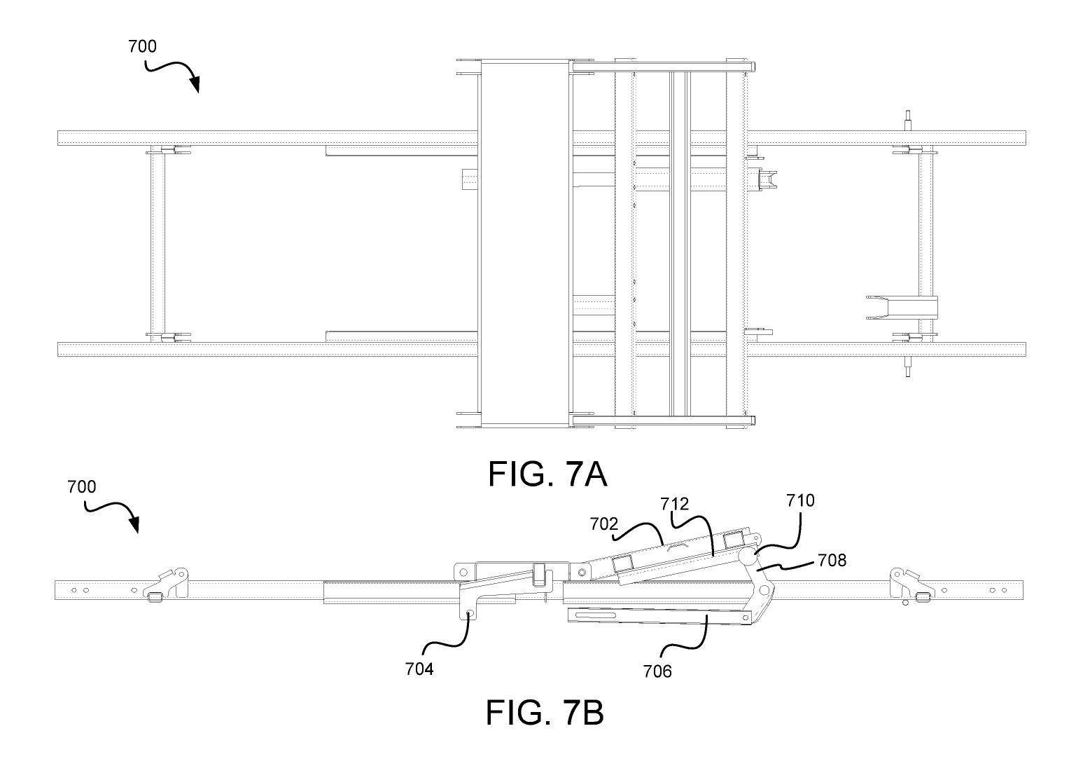

FIGS. 7A and 7B depict views of one embodiment of a bed 700 with an articulating deck section 702. The bed 700 includes the articulating deck section 702, a frame actuator mount 704, a deck section lift lever 708 and a deck section cam bearing 710. The articulating deck section 702 may be rotated in response to a force provided by an actuator (not shown). In one embodiment, a pulling force by the actuator causes at least a portion of the articulating deck section 702 to move in an upward direction. Components of the bed 700 are not shown in the interest of clarity.

In one embodiment, the actuator is connected between the frame actuator mount 704 and the deck section lift lever 708. The actuator may be installed in any orientation. In certain embodiments, the actuator is connected to an actuator extension tube 706. The actuator extension tube 706 may be disposed between the actuator and the deck section lift lever 708 or between the frame actuator mount 704 and the actuator. In some embodiments, an actuator damper may be disposed between the actuator and other components of the bed 700 to mitigate shock loads applied to the actuator.

The deck section lift lever 708, in one embodiment, rotates in response to a force provided by the actuator. Rotation of the deck section lift lever 708 may cause the articulating deck section 702 to articulate. In one embodiment, a pulling force applied to the deck section lift lever 708 may cause the articulating deck section 702 to articulate in an upward direction.

In certain embodiments, the deck section lift lever 708 interacts with the articulating deck section 702 via a cam bearing 710 and a cam bearing surface 712. The cam bearing 710 may translate along the cam bearing surface 712 in response to rotation of the deck section lift lever 708.

The cam bearing 710 may be any type of bearing known in the art. For example, the cam bearing 710 may be a sliding bearing, a roller bearing, or the like. The cam bearing surface 712 may be any type of surface capable of interacting with the cam bearing 710. For example, the cam bearing 710 may be a roller, and the cam bearing surface 712 may be a relatively smooth track on which the cam bearing 710 articulates.

In some embodiments, the deck section lift lever 708, the cam bearing 710 and the cam bearing surface 712 are configured to lift the articulating deck section 702 in response to a pulling force from the actuator. In another embodiment, the deck section lift lever 708, the cam bearing 710 and the cam bearing surface 712 are configured to lift the articulating deck section 702 in response to a pushing force from the actuator. In some embodiments, articulating deck section 702 is lifted in response to a force provided by the actuator and lowered under the force of gravity as the actuator is actuated in the opposite direction.

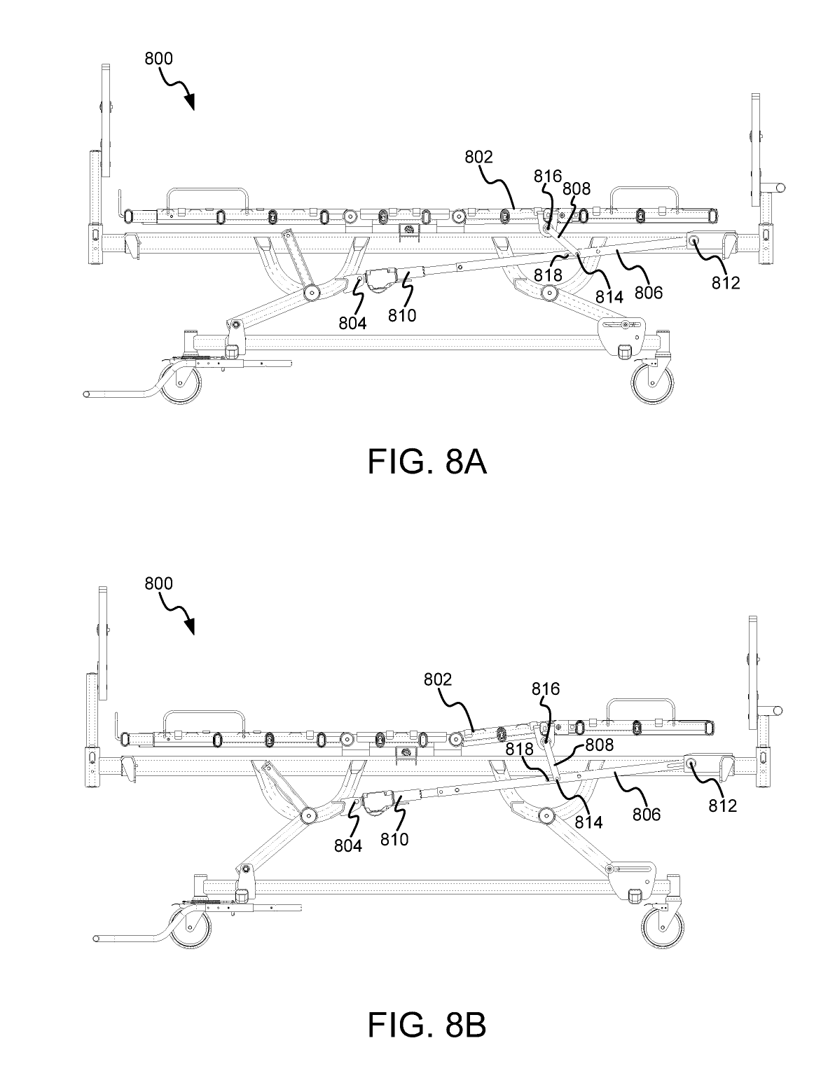

FIGS. 8A and 8B depict cross-sectional views of one embodiment of a bed 800 with a deck link 808. The bed 800 includes an articulating deck section 802, a first frame actuator mount 804, a second frame actuator mount 812, and the deck link 808. The articulating deck section 802 may be rotated in response to a force provided by an actuator 810. In one embodiment, a pulling force by the actuator 810 causes at least a portion of the articulating deck section 802 to move in an upward direction. Some components of the bed 800 are not shown in the interest of clarity.

In one embodiment, the actuator 810 is connected between the first frame actuator mount 804 and the second frame actuator mount 812. The actuator 810 may be installed in any orientation.

The connection at the first frame actuator mount 804 may be a rotatable connection, such that the actuator 810 may pivot relative to the first frame actuator mount 804. In one embodiment, the connection at the first frame actuator mount 804 may be a slidable connection, such that the actuator 810 may slide relative to the first frame actuator mount 804. In one embodiment, the connection at the first frame actuator mount 804 may be a rotatable and slidable connection, such that the actuator 810 may pivot and translate relative to the first frame actuator mount 804.

The connection at the second frame actuator mount 812 may be a rotatable connection, such that the actuator 810 may pivot relative to the second frame actuator mount 812. In one embodiment, the connection at the second frame actuator mount 812 may be a slidable connection, such that the actuator 810 may slide relative to the second frame actuator mount 812. In one embodiment, the connection at the second frame actuator mount 812 may be a rotatable and slidable connection, such that the actuator 810 may pivot and translate relative to the second frame actuator mount 812.

In certain embodiments, the actuator 810 is connected to an actuator extension tube 806. The actuator extension tube 806 may be disposed between the actuator 810 and the first frame actuator mount 804 and the actuator 810 or between the second frame actuator mount 812 and the actuator. In some embodiments, an actuator damper may be disposed between the actuator 810 and other components of the bed 800 to mitigate shock loads applied to the actuator 810.

The deck link 808, in one embodiment, moves in response to a force provided by the actuator 810. The deck link 808 may rotate and/or translate relative to other components of the bed 800. Movement of the deck link 808 may cause the articulating deck section 802 to articulate. In one embodiment, a pulling force applied to the deck link 808 may cause the articulating deck section 802 to articulate in an upward direction.

In some embodiments, the deck link 808 is connected to the extension tube 806. In another embodiment, the deck link 808 is connected to the actuator 810. In the description below, the deck link is described as being connected to the extension tube 806; however, similar operation could be achieved by connecting the deck link 808 to the actuator 810, and such embodiments should be considered to be within the scope of this disclosure.

The deck link 808, in one embodiment, includes a first connection 814 and a second connection 816. The deck link 808 is connected to the extension tube 806 at the first connection 814. In one embodiment, the first connection 814 is at a location disposed between the first frame actuator mount 804 and the second frame actuator mount 812.

The first connection 814 may be a rotatable connection, such that the deck link 808 may pivot relative to the extension tube 806. In one embodiment, the first connection 814 may be a slidable connection, such that the deck link 808 may slide relative to the extension tube 806. In one embodiment, the first connection 814 may be a rotatable and slidable connection, such that the deck link 808 may pivot and translate relative to the extension tube 806.

In some embodiments, the deck link 808 is connected to the articulating deck section 802 at the second connection 816. The second connection 816 may be a rotatable connection, such that the deck link 808 may pivot relative to the articulating deck section 802. In one embodiment, the second connection 816 may be a slidable connection, such that the deck link 808 may slide relative to the articulating deck section 802. In one embodiment, the second connection 816 may be a rotatable and slidable connection, such that the deck link 808 may pivot and translate relative to the articulating deck section 802.

In certain embodiments, the deck link 808 rotates toward a vertical orientation in response to retraction of the actuator 810. Rotation toward a vertical orientation may cause the second connection 816 to move to a relatively higher position and cause the articulating deck section 802 to rotate upward.

In some embodiments, a force generated between the deck link 808 and the extension tube 806 in response to retraction of the actuator 810 has a substantial component that is perpendicular to a long axis of the actuator 810. In some embodiments, the long axis of the actuator 810 is along a line between the first frame actuator mount 804 and the second frame actuator mount 812. In some embodiments, if the force applied to the extension tube 806 by the deck link 808 is broken into a component parallel to the long axis of the actuator 810 and a component perpendicular to the long axis of the actuator 810, the component perpendicular to the long axis of the actuator 810 is greater than the component parallel to the long axis of the actuator 810. In another embodiment, the force component perpendicular to the long axis of the actuator 810 is at least half the magnitude of the component parallel to the long axis of the actuator 810.

One or more connections of the bed 800 may allow one or more components to freely slide. In some embodiments, this free-sliding connection may allow the articulating deck section 802 to be lifted to a relatively raised position without actuation of the actuator 810. For example, the extension tube 806 may have a slot 818 where the first connection 814 connects the extension tube 806 to the deck link 808. The first connection 814 may freely translate along the slot 818 in response to manually raising the articulating deck section 802. Other connections may similarly slide freely in one direction, including but not limited to the second connection 816, the first frame actuator mount 804, and the second frame actuator mount 812.

One or more connections of the bed 800 may include a bearing. The bearing may be any known type of bearing. For example, a connection may include a sliding bearing, a roller bearing, or the like. A bearing may include any type of material capable of transmitting forces and allowing desired movement.

One or more connections of the bed 800 may include a compliant component configured to absorb shock transmitted between one or more components of the bed 800. For example, a shock absorbing device, such as a compliant rubber component, may be disposed at the second connection 816 between the articulating deck section 802 and the deck link 808. In another example, a compliant structure such as that described in relation to FIGS. 6A and 6B may be disposed between the second frame actuator mount 812 and the extension tube 806. In some embodiments, multiple compliant components may be incorporated at multiple connection points. A compliant component may be disposed at any connection point, including, but not limited to, the first connection 814, the second connection 816, the first frame actuator mount 804, and the second frame actuator mount 812.

In some embodiments, the deck link 808 is not rigid. For example, the deck link 808 may be a shock absorbing device, such as an air spring or a mechanical spring. In another embodiment, the deck link 808 is substantially rigid. For example, the deck link 808 may be steel.

In some embodiments, the deck link 808 is configured to lift the articulating deck section 802 in response to a pulling force from the actuator 810. In another embodiment, the deck link 808 is configured to lift the articulating deck section 802 in response to a pushing force from the actuator 810. In some embodiments, articulating deck section 802 is lifted in response to a force provided by the actuator 810 and lowered under the force of gravity as the actuator 810 is actuated in the opposite direction.

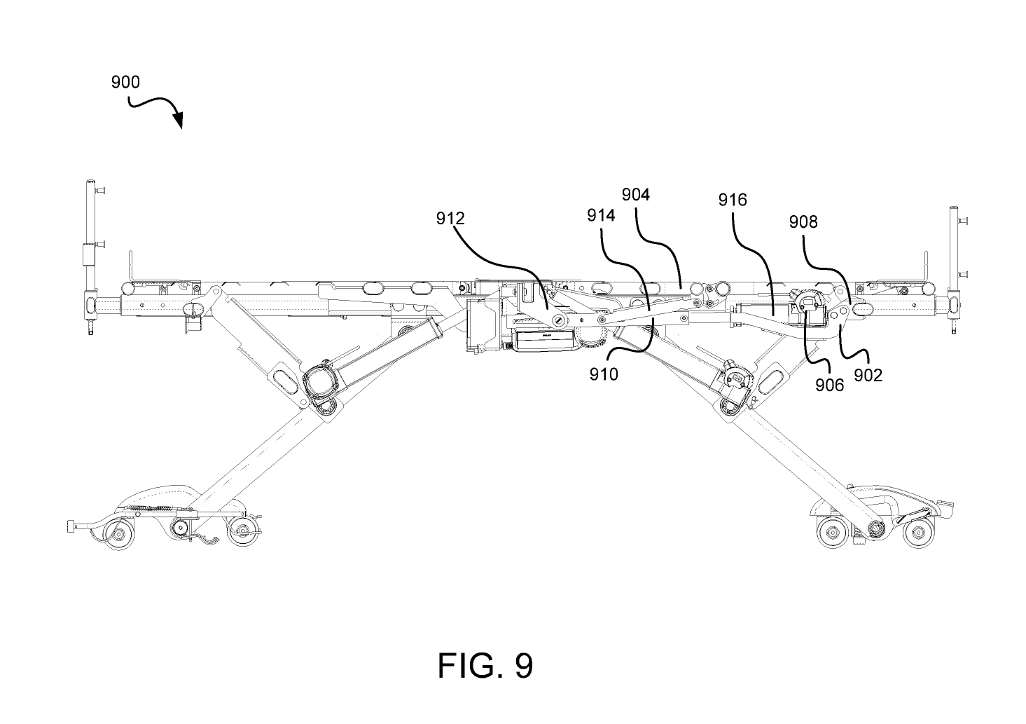

FIG. 9 depicts a side view of one embodiment of a bed 900 with a shock absorbing frame 902. The bed includes an articulating deck 904 that rotates in an upward direction in response to retraction of an actuator 906.

The actuator 906, in one embodiment, is connected to a first actuator mount 908 at a first connection point of the actuator. The actuator 906 may be connected to an extension tube 910 at a second connection point. In some embodiments, the actuator 906 is connected to a second actuator mount 912 at the second connection point.

In certain embodiments, any connections between any of the actuator 906, the first actuator mount 908, and the second actuator mount 912 may be substantially rigid connections, rotatable connections, slideable connections, or slideable and rotatable connections. For example, the connection between the actuator 906 and the first actuator mount 908 may be a substantially rigid connection and the connection between the actuator 906 or the extension tube 910 and the second actuator mount 912 may be a slideable connection. In some embodiments, the connection between the actuator 906 or the extension tube 910 and the second actuator mount 912 is a compliant connection

The extension tube 910 may be connected to a deck link 914 at a first deck link connection in some embodiments. The deck link 914 may be connected to the articulating deck 904 at a second deck link connection. The deck link 914 may rotate toward a vertical orientation in response to retraction of the actuator 906. A portion of the articulating deck 904 rotates in an upward direction in response to rotation of the deck link 914 toward a vertical orientation in some embodiments.

The shock absorbing frame 902, in some embodiments, is connected to the first actuator mount 908. In certain embodiments, the shock absorbing frame 902, in some embodiments, is connected to another non-articulating component of the bed 900. In another embodiment, the shock absorbing frame 902 is formed integrally with the first actuator mount 908, such as by casting or machining the shock absorbing frame 902 and the first actuator mount 908 into a unitary whole, or by welding the shock absorbing frame 902 and the first actuator mount 908 together into a unitary whole.

In one embodiment the shock absorbing frame 902 is rigidly connected to the first actuator mount 908. In another embodiment, the shock absorbing frame 902 is substantially rigidly connected to the first actuator mount. In certain embodiments, a substantially rigid connection allows for a predetermined degree of rotation. In some embodiments, a substantially rigid connection allows for a predetermined degree of translation. Some embodiments of a substantially rigid connection allow for a predetermined degree of rotation and a predetermined degree of translation. For example, a substantially rigid connection between the shock absorbing frame 902 and the first actuator mount 908 may include a pin having a diameter smaller than a hole in which the pin is disposed. The pin may allow for some translation and rotation within the hole and allow for a predetermined amount of rotation and translation between the shock absorbing frame 902 and the first actuator mount 908.

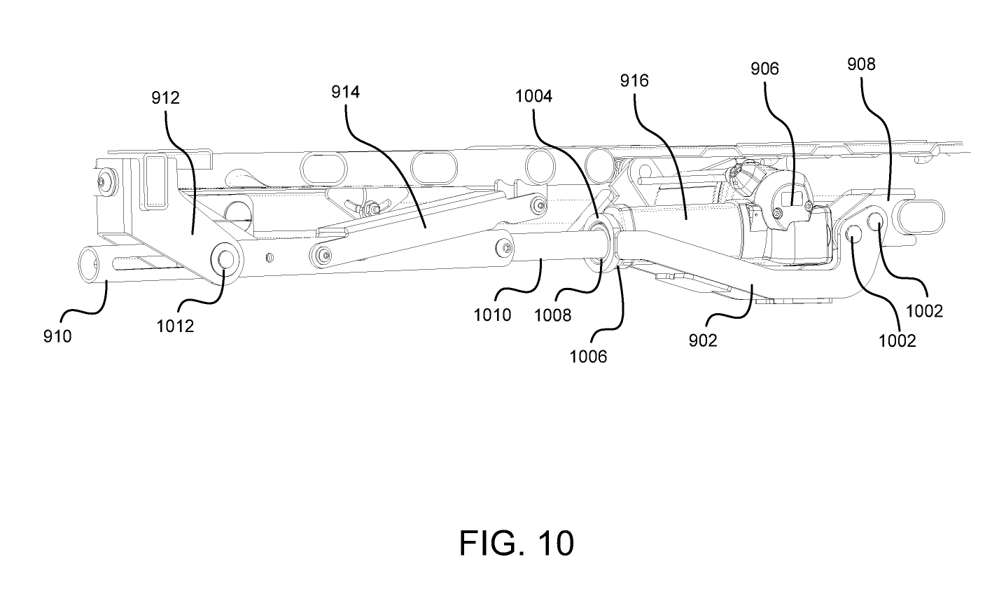

In certain embodiments, the shock absorbing frame 902 restricts motion of a housing 916 of the actuator 906. The shock absorbing frame 902 is described in greater detail in relation to FIG. 10 below.

FIG. 10 depicts a cutaway perspective view of one embodiment of the shock absorbing frame 902 of FIG. 9. The shock absorbing frame 902 interacts with the actuator 906 to restrict movement of the housing 916 relative to the first actuator mount 908.

In some embodiments, the shock absorbing frame 902 is connected to the first actuator mount 908. The connection between the shock absorbing frame 902 and the first actuator mount 908 may include a plurality of fasteners 1002. For example, the plurality of fasteners may include two pins that pass through holes in the shock absorbing frame 902 and the first actuator mount 908. In an alternate embodiment, the plurality of fasteners 1002 may include any type of fastener known in the art, such as bolts, screws, or the like.

The shock absorbing frame 902 includes a housing interface surface 1004 in some embodiments. The housing interface surface 1004 may interfere with movement of the housing 916 of the actuator 906. In one embodiment, the housing interface surface 1004 restricts translation of the housing 916 away from the first actuator mount 908. Restricting translation of the housing 916 away from the first actuator mount 908 may improve the durability of the actuator 906 in response to forces generated during retraction of the actuator 906.

The shock absorbing frame 902, in some embodiments, may include any known material strong and rigid enough to restrict translation of the housing 916 away from the first actuator mount 908. For example, the shock absorbing frame 902 may include a metal, such as steel, aluminum, or an alloy.

In some embodiments, the housing interface surface 1004 contacts the housing 916. In another embodiment, the housing interface surface 1004 interacts with the housing 916 through a compliant component 1006. For example, a compliant bushing may be disposed between the housing interface surface 1004 and the housing 916 to act as a compliant component 1006. The compliant component 1006 may absorb shocks that would otherwise be translated to the actuator 906 and mitigate damage to the actuator 906 under load.

The compliant component 1006 may include any material known in the art capable of deforming in response to a shock load. For example the compliant component 1006 may include a flexible polymer. In one example, the compliant component 1006 includes a thermoplastic elastomer (“TPE”), including but not limited to Styrenic block copolymers (TPE-s), Polyolefin blends (TPE-o), Elastomeric alloys (TPE-v or TPV), Thermoplastic polyurethanes (TPU), Thermoplastic copolyester, or Thermoplastic polyamide. In another example, the compliant component 1006 may include polyvinyl chloride (PVC), low durometer PVC, or a urethane.

In some embodiments, the housing interface surface 1004 includes an aperture 1008 through which an output rod 1010 of the actuator 906 is disposed. The output rod 1010 may be free to move relative to the housing interface surface 1004 in response to activation of the actuator 906 subject to other constraints placed on the actuator 906.

In certain embodiments, connections include a compliant structure to mitigate shocks in the system. For example, the connection between the extension tube 910 and the second actuator mount 912 may include a bushing 1012 that incorporates a compliant material to absorb shock. The compliant material 1012 may include any material known in the art capable of deforming in response to a shock load. For example the compliant component 1012 may include a flexible polymer. In one example, the compliant component 1012 includes a thermoplastic elastomer (“TPE”), including but not limited to Styrenic block copolymers (TPE-s), Polyolefin blends (TPE-o), Elastomeric alloys (TPE-v or TPV), Thermoplastic polyurethanes (TPU), Thermoplastic copolyester, or Thermoplastic polyamide. In another example, the compliant component 1012 may include polyvinyl chloride (PVC), low durometer PVC, or a urethane.

As used herein, “up” and “raised” refer to a direction substantially away from a base on which a bed is disposed, such as a floor. Similarly, as used herein, “down” and “lowered” refer to a direction substantially toward a base on which a bed is disposed, such as a floor.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. A bed with an actuated deck section comprising:
a deck section configured to articulate;
a non-articulating component; and
an actuator in operative communication with the deck section and the non-articulating component;
wherein at least a portion of the deck section is in an elevated position in response to an output rod of the actuator being in a relatively retracted position.

2. The bed of claim 1 wherein a connection between two of the actuator, the deck section, and the non-articulating component includes a sliding connection that allows the deck to remain in the elevated position when the output rod of the actuator moves to a relatively extended position.

3. The bed of claim 2 wherein the sliding connection comprises a slot and a pin, the pin configured to translate within the slot.

4. The bed of claim 3 wherein the slot is sized to restrict motion of the pin to a predetermined range.

5. The bed of claim 3 wherein the pin translates toward a distal end of the slot in response to retraction of the actuator, the distal end of the slot farthest from the actuator.

6. The bed of claim 2 wherein the actuator comprises an extension tube connected to an output rod of the actuator.

7. The bed of claim 1 further comprising an actuator damper comprising a compliant component, the compliant component to deform under a shock load applied to the deck section, the actuator damper in operable communication with the actuator.

8. The bed of claim 7 wherein the actuator damper comprises a coil spring.

9. The bed of claim 7 wherein the actuator damper comprises a shock absorber.

10. The bed of claim 7 wherein the actuator damper comprises a polymer.

11. The bed of claim 7 wherein the actuator damper is connected to an output rod of the actuator.

12. A bed with an actuated deck section comprising:
a deck section configured to articulate;
a non-articulating component an actuator connected to one of the deck section and the non-articulating component;
an actuator damper comprising a compliant component, the compliant component to deform under a shock load applied to the deck section, the actuator damper connected to the actuator;
wherein at least a portion of the deck section is in an elevated position in response to an output rod of the actuator being in a relatively retracted position.

13. The bed of claim 12, wherein the actuator is operably connected to the deck section by a lift lever that rotates a cam upward.

14. The bed of claim 12, wherein the actuator is operably connected to the deck section by a deck link configured to rotate toward a vertical orientation in response to retraction of the actuator.

15. The bed of claim 14, wherein a force applied to the actuator by the deck link has a component perpendicular to the long axis of the actuator that is greater than a component parallel to the long axis of the actuator.

16. The bed of claim 14, wherein the deck link comprises a compliant structure.

17. The bed of claim 14, further comprising:
a shock absorbing frame connected to the one of the deck section and the non-articulating component;
wherein the shock absorbing frame comprises a housing interface surface in operable communication with a housing of the actuator; and
wherein the housing interface surface restricts translation of the housing in response to retraction of the actuator.

18. A method of assembling a bed with an actuated deck section comprising:
connecting a deck section configured to articulate to a non-articulating component;
connecting an actuator to the non-articulating component;
connecting an actuator damper to the actuator, the actuator damper comprising a compliant component, the compliant component configured to deform under a shock load applied to the deck section;
wherein at least a portion of the deck section is in an elevated position in response to an output rod of the actuator being in a relatively retracted position.

19. The method of claim 18, further comprising:
disposing an output rod of the actuator through an aperture of a shock absorbing frame; and
connecting the shock absorbing frame to the non-articulating component.

20. The method of claim 19, further comprising disposing a compliant component between the shock absorbing frame and a housing of the actuator.
